(19) United States
(12) Patent Application Publication
(10) Pub. No.: US 2009/0220781 A1
(43) Pub. Date: Sep. 3, 2009

(54) Composite System, Associated Use And Method For The Oxygen-Free Packaging Of Items Susceptible to Oxidation

(75) Inventors: Thomas Wanner, Schrobenhausen (DE); Wolfgang Lohwasser, Gailingen (DE)

Correspondence Address: GIBSON & DERNIER L.L.P., 900 ROUTE 9 NORTH, SUITE 504, WOODBRIDGE, NJ, 07095, US

(73) Assignees: ALCAN TECHNOLOGY & MANAGEMENT LTD., Neuhausen (CH); FRAUNHOFER-GESELLSCHAFT ZUR FÖRDERUNG DER ANGEWANDTEN FORSCHUNG E.V., MÜNCHEN (DE)

(21) Appl. No.: 12/092,595

(22) PCT Filed: Nov. 17, 2006
(86) PCT No.: PCT/EP06/11078

§ 371 Date: Aug. 12, 2008

(30) Foreign Application Priority Data
Nov. 22, 2005 (DE) 102005055632.9

(51) Int. Cl. B32B 15/09; B32B 15/04; B65B 31/04

(52) U.S. Cl. 428/336; 428/450; 428/412; 53/403

(57) ABSTRACT

The invention relates to a thin-film composite system which has at least one substrate film and at least one thin film. The catalyst thereby catalyses the reduction of oxygen, as a result of which oxygen which is detrimental to oxidation-susceptible packaging items is consumed. The composite system according to the invention is used also in the form of bag films, cover films or partially applied individual films for oxygen-susceptible packaging items. A method for oxygen-free packaging of oxidation-susceptible packaging items is likewise provided.

### FIELD OF THE INVENTION

The invention relates to a thin-film composite system which has at least one substrate film and at least one thin film. The catalyst thereby catalyses the reduction of oxygen, as a result of which oxygen which is detrimental to oxygen-susceptible packaging items is consumed. Therefore the composite system according to the invention is used also in the form of bag films, cover films or partially applied individual films for oxygen-susceptible packaging items. According to the invention, a method for oxygen-free packaging of oxygen-susceptible packaging items is likewise provided.

### BACKGROUND

In the case of packagings known from the state of the art with a modified gas atmosphere, usually a packaging is equipped with the packaging item and subsequently purged by means of a gas purge with an inert gas, e.g. with nitrogen, and subsequently is sealed. It is hereby the aim to keep the remaining gas space in the packaging as free of oxygen as possible. However it is revealed here in the method known from the state of the art that the residual oxygen content in the headroom of the packaging cannot be reduced below 0.5 to 2% by volume with this method. In the case of oxygen-susceptible packaging items, in particular foodstuffs, this low residual oxygen content already leads over the storage time to qualitative impairment of the packaging item.

A variant for resolving this problem provides that oxygen adsorber materials are incorporated in a packaging film or else are inserted in packagings in the form of additional bags which contain these oxygen adsorber materials. However, this technology also entails disadvantages. Thus systems of this type are often not transparent, e.g. when using iron oxide in the plastic material, or they react relatively slowly as a result of which the oxidation of the packaging item in the case of susceptible packaging items proceeds more rapidly than that of the oxygen adsorber.

### SUMMARY OF THE INVENTION

Starting herefrom, it was the object of the present invention to provide a packaging system which makes possible, directly after the packaging, a high-grade oxygen-free headroom atmosphere and which, at the same time, can be produced simply and cost-effectively.

This object is achieved by the thin-film composite system having the features of at least one substrate film and at least one thin film disposed thereon, which comprises at least one catalyst for the reduction of oxygen and by the method for oxygen-free packaging oxidation-susceptible packaging items in which the packaging item is inserted in a compartment comprising a composite system according to one of the preceding claims, is purged with an inert gas mixed with a reducing gas and is sealed in a gas-tight manner. Uses according to the invention may include us of the system with or as packaging film, bag film or partially applied individual film. Further advantageous developments are described herein.

### BRIEF DESCRIPTION OF THE DRAWINGS

FIG. 1 is a graphical depiction showing reduction in oxygen partial pressure in a compartment over time in accordance with at least one embodiment of the present invention.

### DETAILED DESCRIPTION OF THE INVENTION

According to the invention, a composite system is provided which comprises at least one substrate film and at least one thin film disposed thereon. The thin film in turn contains at least one catalyst for the reduction of oxygen.

There are understood according to the invention by thin film all the layer systems which can be produced on a nano scale by vacuum coating methods (CVD and PVD) and also electrolytic deposition or painting.

The concept according to the invention is based on the fact that a reduction in the oxygen is produced with the help of the catalyst, the oxygen contained in the headroom of a packaging being converted catalytically by the addition of small quantities of a reducing gas. An example of this is the hydrogen-oxygen reaction:

H₂+½O₂→H₂O

The system according to the invention described here hence concerns an O₂ scavenger system. The oxygen found in the atmosphere is removed by the catalytic conversion.

There can be used as catalysts for the reduction of oxygen basically all the catalysts known from the state of the art. Preferably, the catalyst is a noble metal, e.g. palladium or platinum. Another preferred variant provides that the catalyst is a metal oxide or a metallic mixed oxide, in particular Co₃O₄ or the mixed oxide Mn—CuO-Ag₂O.

The catalyst is preferably applied as a film which is as thin as possible, particularly preferred as monoatomic layer. This is intended to ensure, on the one hand, the optical transparency in the wave range of the spectrum of visible light, on the other hand, to keep the production costs as low as possible.

Preferably, the thin layer is vapour-deposited onto the substrate film in a vacuum. Thin-film technology thereby enables economical use of the otherwise very expensive catalyst material.

The thin film preferably has a film thickness of 0.01 to 50 nm, in particular 1 to 50 nm. The thickness of the layer which is used and the surface structure thereof is thereby dependent upon the required scavenger kinetics. The oxygen to be reduced can thereby diffuse, just like the hydrogen, through the composite system to the catalyst layer and there is converted catalytically into hydrogen.

The substrate film can likewise consist of a composite film. A preferred variant provides that the substrate film has a barrier layer for oxygen which prevents the oxygen permeation through the composite system. For particular preference, the barrier layer described here consists of SiOₓ with x=1.0 to 2.0, AlO_{y} with y=1.3 to 1.6, ethylene vinyl alcohol copolymers and/or vinylidene chloride copolymers.

With respect to the substrate film there are otherwise no substantial restrictions. Thus all the plastic materials known from the packaging field can preferably be used here. Preferably, the substrate film consists of polyethylene terephthalate (PET), polyolefins, in particular polypropylene (PP) and polyethylene (PE), polyamides (PA), polystyrenes (PS), pen (PS), polycarbonates and also the copolymers and/or polymer blends thereof.

A further preferred embodiment of the thin-film composite system according to the invention provides that the catalyst layer is enclosed at least in regions in a frictional fit between the substrate film and a further layer in the manner of a sandwich. The further layer can thereby preferably be applied with an adhesive backing at least in regions in a frictional fit. There can be considered as further layer hereby preferably a paint layer, an adhesive backing layer or a polymer film. The polymer can thereby be selected particularly preferably from the group of polyethylene terephthalates, polyolefins, in particular polypropylene and polyethylene, polyamides, polystyrenes, polycarbonates, ionomers and also the copolymers and/or polymer blends thereof. There should hereby be mentioned in particular ethylene (meth)acrylic acid copolymers. Just as for the substrate film, there are no substantial restrictions with respect to the material of the cover film, so that any polymers which are used in the packaging field can also be used here. The cover film particularly preferably comprises polyethylene.

A further preferred variant provides that the composite system according to the invention has transparent properties in the wave length range of the spectrum of visible light. This means that the composite system displays no discolouration or cloudiness for an observer.

A further variant provides that the composite system according to the invention comprises in addition an emitter for a reducing gas, in particular an H₂ emitter. For this purpose, basically all the compounds and systems are suitable which are able to release hydrogen. There are included herein for example a system consisting of an acid and a non-noble metal, i.e. a metal with a low normal potential, e.g. zinc and hydrochloric acid. A further example of H₂ emitters is a system consisting of metal hydrides and water, in which the result is formation of metal hydroxide and hydrogen due to reactive conversion. A further example is the conversion of iron chloride and water in which hydrogen can likewise be released.

According to the invention, a method for oxygen-free packaging of oxidation-susceptible packaging items is likewise provided. The packaging item is hereby inserted firstly into a thin-film composite system, as was described previously. Packaging item and composite system are purged then with an inert gas, in particular nitrogen. Optionally, it is also possible that the headroom of the packaging is evacuated first. It is now essential for the invention that small quantities of hydrogen are added to the inert gas, by means of which the catalytic conversion of the oxygen is made possible. After purging of the system, gas-tight sealing of the packaging is then effected. In conjunction with the catalyst layer, an almost immediate conversion of the hydrogen with the residual hydrogen into water is then effected in the headroom of the packaging.

Preferably, 0.5 to 20% by volume of hydrogen are added to the inert gas.

The composite systems according to the invention are used preferably as packaging film, bag film or as partially applied individual film. The described composite systems are thereby outstandingly suitable as packaging films for any packaging items, in particular foodstuffs. The composite system according to the invention can also be used as individual film in a product itself, e.g. as film in an electrical appliance in order to ensure the function thereof if individual components of the appliance are extremely sensitive to moisture. The application cases thereby concern the foodstuff industry, pharmaceutical products and appliances, the electronics industry, the chemical industry but also cultural and military fields.

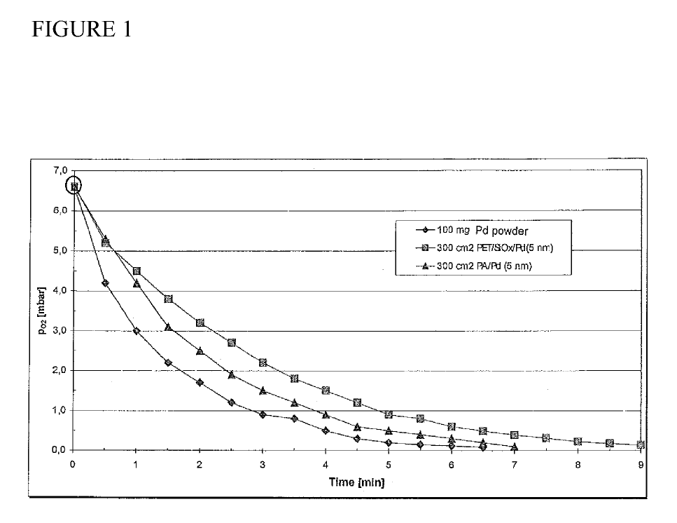

The subject according to the invention is intended to be explained in more detail with reference to the subsequent FIG. 1 without wishing to restrict said subject to the special embodiment shown here.

The FIG. 1 shows the reduction in oxygen partial pressure in a compartment over time. In the compartment there is, as catalyst, palladium and a gas mixture consisting of oxygen, hydrogen and nitrogen. The oxygen is converted into water at the catalyst with the hydrogen. This catalytic reaction is the basis of the reduction in oxygen partial pressure over time. In the FIG. 1, three different composite systems according to the invention are compared. The first uses pulverulent palladium, the second represents a composite system comprising PET and SiOₓ with x=1.0 to 2.0, which is vapour-deposited with palladium, and the third represents a film made of polyamide which is vapour-deposited with palladium.

It is evident from the FIG. 1 that both the pulverulent palladium and also the vapour-deposited palladium layers reduce the oxygen from a partial pressure pO₂=7 mbar to below 0.1 mbar within less than 9 minutes.

1. A composite system comprising at least one substrate film and at least one thin film disposed thereon, which comprises at least one catalyst for the reduction of oxygen.

2. A composite system according to claim 1, wherein the catalyst for the reduction of oxygen is a noble metal.

3. A composite system according to claim 2, wherein the noble metal is palladium or platinum.

4. A composite system according to claim 1 wherein the catalyst is a metal oxide or a metallic mixed oxide.

5. A composite system according to claim 4, wherein the metal oxide is MnO₂—CuO-Ag₂O or Co₃O₄.

6. A composite system according to claim 1 wherein the catalyst is applied as a monoatomic layer.

7. A composite system according to claim 1 wherein the thin film is vapour-deposited onto the substrate film in a vacuum.

8. A composite system according to claim 1 wherein the thin film has a thickness in the range of 0.01 to 50 nm.

9. A composite system according to claim 1 wherein the thin film is transparent in the wave length range of the spectrum of visible light.

10. A composite system according to claim 1 wherein the substrate film is a composite film.

11. A composite system according to claim 10, wherein the substrate film comprises a barrier layer for oxygen.

12. A composite system according to claim 11, wherein the barrier layer comprises one or more of SiOₓ with x=1.0 to 2.0, AlO_{y} with y=1.3 to 1.6, ethylene vinyl alcohol copolymers and/or vinylidene chloride copolymers.

13. A composite system according to claim 10, wherein the substrate film comprises one or more materials selected from the group of polyethylene terephthalates, polyolefins, polyamides, polystyrenes, polycarbonates and copolymers and polymer blends thereof.

14. A composite system according to claim 1 wherein the thin film is enclosed at least in regions in a frictional fit between the substrate film and a further layer in the manner of a sandwich.

15. A composite system according to claim 14, wherein the further layer is a paint layer, an adhesive backing layer or a polymer film.

16. A composite system according to claim 15, wherein the polymer film comprises one or more materials selected from the group of polyethylene terephthalates, polyolefins, polyamides, polystyrenes, polycarbonates and copolymers and polymer blends thereof.

17. A composite system according to claim 1 wherein the composite system is transparent in the wave length range of the spectrum of visible light.

18. A composite system according to claim 1 wherein the composite system comprises an emitter for a reducing gas.

19. A composite system according to claim 18, wherein the emitter is a hydrogen emitter and the hydrogen emitter consists essentially of an acid and a metal with a low normal potential.

20. A composite system according to claim 19, wherein the hydrogen emitter consists essentially of a metal hydride and water.

21. A method for oxygen-free packaging of at least one oxidation-susceptible packaging item, comprising inserting the packaging item in a compartment comprising a composite system according to claim 1, purging the compartment with an inert gas mixed with a reducing gas and sealing the compartment in a gas-tight manner.

22. A method according to claim 21, wherein the inert gas is nitrogen.

23. A method according to claim 21, wherein the inert gas contains from 0.5 to 20% by volume of the reducing gas.

24. An article comprising the composite system according to claim 1 selected from a packaging film, bag film and/or partially applied individual film.
